(19) United States
(12) Patent Application Publication
(10) Pub. No.: US 2025/0065406 A1
(43) Pub. Date: Feb. 27, 2025

(54) METHOD AND DEVICE FOR CALIBRATING AN IRRADIATION SYSTEM, COMPUTER PROGRAM PRODUCT AND APPARATUS FOR PRODUCING A THREE-DIMENSIONAL WORK PIECE

(71) Applicant: NIKON SLM SOLUTIONS AG, Luebeck (DE)

(72) Inventor: Philipp Rohse, Luebeck (DE)

(21) Appl. No.: 18/718,970

(22) PCT Filed: Jan. 20, 2023
(86) PCT No.: PCT/EP2023/051307

§ 371 Date: Jun. 12, 2024

(30) Foreign Application Priority Data
Jan. 26, 2022 (DE) 10 2022 101 771.0

(51) Int. Cl. B22F 10/31; B22F 10/28; B22F 12/45; B22F 12/49; B22F 12/90

(52) U.S. Cl. CPC B22F 10/31; B22F 10/28; B22F 12/45; B22F 12/49; B22F 12/90

(57) ABSTRACT

A method for calibrating an irradiation system (10) for use in an apparatus (100) for producing a three-dimensional work piece is described. The method comprising the step of i) setting a distance between a calibration plane (30) and an optical unit (16) of the irradiation system (10) in a z-direction perpendicular to the calibration plane (30) to a first distance (z₁). In a step ii), while maintaining the distance between the calibration plane (30) and the optical unit (16) at the first distance (z₁), a first calibration pattern (p_{1,1}) is irradiated in a first x-y region (a₁) within the calibration plane (30) with a scanner mirror (22) of the optical unit (16) being arranged in a first angular basic position. A second calibration pattern (p_{2,1}) is irradiated in a second x-y region within the calibration plane (30) with the scanner mirror (22) of the optical unit (16) being arranged at a second angular basic position in which the scanner mirror (22) is pivoted relative to the first angular basic position by at least ±1°. In a step iii) the distance between the calibration plane (30) and the optical unit (16) in the z-direction is set to a second distance (z₂) different from the first distance (z₁). In a step iv), while maintaining the distance between the calibration plane (30) and the optical unit (16) at the second distance (22), a third calibration pattern (p_{1,2}) is irradiated in the first x-y region (a₁) with the scanner mirror (22) of the optical unit (16) being arranged in the first angular basic position, and a fourth calibration pattern (p_{2,2}) is irradiated in the second x-y region (a₂) with the scanner mirror (22) of the optical unit (16) being arranged in the second angular basic position. In a step v) the first, the second, the third and the fourth calibration pattern (p_{1,1}, p_{2,1}, p_{1,2}, p_{2,2}) are evaluated so as to determine focus positions of the radiation beam (14) in the z-direction in dependence on an x-y position within the calibration plane (30). In a step vi) the irradiation system (10) is calibrated based on the determined focus positions of the radiation beam (14).

The present invention relates to a method and a device for calibrating an irradiation system for use in an apparatus for producing a three-dimensional work piece by irradiating layers of a raw material powder with a radiation beam. Further, the invention is directed to a computer program product comprising program portions for performing the method calibrating an irradiation system when the computer program product is executed on one or more computing devices. Finally, the invention is directed to an apparatus for producing a three-dimensional work piece by irradiating layers of a raw material powder with a radiation beam.

Powder bed fusion is an additive layering process by which powderulent, in particular metallic and/or ceramic raw materials can be processed to three-dimensional work pieces of complex shapes. To that end, a raw material powder layer is applied onto a carrier and subjected to electromagnetic or particle radiation in a site selective manner in dependence on the desired geometry of the work piece that is to be produced. The radiation penetrating into the powder layer causes heating and consequently melting or sintering of the raw material powder particles. Further raw material powder layers are then applied successively to the layer on the carrier that has already been subjected to laser treatment, until the work piece has the desired shape and size. Powder bed fusion can be used in particular for the production of prototypes, tools, replacement parts or medical prostheses, such as, for example, dental or orthopaedic prostheses, on the basis of CAD data.

An irradiation system which may be employed in an apparatus for producing three-dimensional work pieces by irradiating pulverulent raw materials is described, e.g., in EP 2 335 848 B1. The irradiation system comprises a radiation source, in particular a laser source, and an optical unit. The optical unit which is supplied with a radiation beam emitted by the radiation source comprises a beam expander, a scanner unit and an objective lens which is designed in the form of an f-theta lens.

The scanner unit typically comprises a scanner mirror, which is pivotable about a pivot axis in order to deflect the radiation beam emitted by the radiation source of the irradiation system at the desired irradiation spots of the raw material powder layer. Due to the use of a pivotable scanner mirror, a focal plane of the deflected radiation beam is curved, whereas an irradiation plane, which might, e.g., be defined by a surface of or a plane within the raw material powder layer to be irradiated, typically is flat. Thus, a focus offset in a direction perpendicular to the irradiation plane (z-direction) exists which depends on a pivot angle of the scanner mirror and hence on an irradiation position within the irradiation plane, i.e. an x-y position at which the radiation beam impinges on the irradiation plane. The focus offset may be compensated for with the aid of either flat field optics or by focus tracking using a suitably adjustable optical element.

The focus offset compensation achieved by known offset compensation means may, however, be insufficient, e.g. due to incorrect or insufficient compensation or due the presence of optical elements which influence the focus offset but which are not considered in the focus offset compensation. Further, if the focus offset compensation is based on focus position measurements which involve an adjustment of the focus position by means of the scanner optic, the adjustment itself may deteriorate the accuracy of the focus offset compensation.

The invention is directed at the object to provide a method, device and computer program product for accurately calibrating an irradiation system for use in an apparatus for producing a three-dimensional work piece by irradiating layers of a raw material powder with a radiation beam. Further, the invention is directed at the object to provide an apparatus for producing a three-dimensional work piece by irradiating layers of a raw material powder with a radiation beam emitted by an irradiation system which can be accurately calibrated.

The invention is set out in the independent claims. Preferred embodiments of the invention are outlined in the dependent claims.

The present disclosure concerns a method for calibrating an irradiation system for use in an apparatus for producing a three-dimensional work piece by irradiating layers of a raw material powder with a radiation beam emitted by the irradiation system. The radiation beam emitted by the irradiation system may be a beam of electromagnetic radiation or particle radiation. Further, the irradiation system to be calibrated with the method described herein may be a multi beam irradiation system which is configured to emit a plurality of radiation beams.

The irradiation system may comprise a radiation source, in particular a laser source, for example a diode pumped Ytterbium fibre laser. The irradiation system may be provided with only one radiation source. In particular in case the irradiation system is designed in the form of a multi beam irradiation system, it is, however, also conceivable that the irradiation system is equipped with a plurality of radiation sources. Further, the irradiation system comprises an optical unit. The optical unit is equipped with a scanner with a pivotable scanner mirror which is adapted to scan the radiation beam across the raw material powder layers to be irradiated, while changing and adapting the position of a focus of the radiation beam both in the direction of the beam path and in a plane perpendicular to the beam path. Besides the scanner, the irradiation system, in particular the optical unit, may comprise a beam expander for expanding a radiation beam emitted by the radiation source and an object lens, in particular a f-theta object lens. Alternatively, the irradiation system may comprise a beam expander including a focusing optic.

The method for calibrating an irradiation system comprises a step i) of setting a distance between a calibration plane and an optical unit of the irradiation system in a z-direction perpendicular to the calibration plane to a first distance. A surface area and/or a contour of the calibration plane may correspond to a surface area and/or a contour of the irradiation plane which is irradiated by the radiation beam during normal operation of the apparatus. The calibration plane may, however, be offset relative to the irradiation plane in the z-direction. The distance between the calibration plane and the optical unit may be measured between the calibration plane and a housing of the optical unit.

In a step ii), while maintaining the distance between the calibration plane and the optical unit at the first distance, a first calibration pattern is irradiated in a first x-y region within the calibration plane with the scanner mirror of the optical unit being arranged in a first angular basic position. Moreover, a second calibration pattern is irradiated in a second x-y region within the calibration plane with the scanner mirror of the optical unit being arranged at a second angular basic position in which the scanner mirror is pivoted relative to the first angular basic position by at least ±1°.

Thereafter, in a step iii), the distance between the calibration plane and the optical unit of the irradiation system in the z-direction perpendicular to the calibration plane is set to a second distance different from the first distance. In a step iv), while maintaining the distance between the calibration plane and the optical unit at the second distance, a third calibration pattern is irradiated in the first x-y region within the calibration plane with the scanner mirror of the optical unit being arranged in the first angular basic position. Moreover, a fourth calibration pattern is irradiated in the second x-y region within the calibration plane with the scanner mirror of the optical unit being arranged in the second angular basic position in which the scanner mirror is pivoted relative to the first angular basic position by at least ±1°.

For setting the distance between the calibration plane and the optical unit of the irradiation system in steps i) and iii), the optical unit may be moved in the z-direction perpendicular to the calibration plane relative to the calibration plane. This may be achieved by moving the entire irradiation system or only the optical unit relative to the calibration plane, for example by displacing a carrier structure of the irradiation system or the optical unit. Preferably, however, the distance between the calibration plane and the optical unit of the irradiation system is set by moving the calibration plane in the z-direction perpendicular to the optical unit of the irradiation system.

Within the context of this application, the expression “x-y region” defines a region of the calibration plane which is small as compared to the total calibration plane. In particular, each of the x-y regions defined within the calibration plane has a surface area that is less than 5%, preferably less than 1%, further preferably less than 0.5% and in particular less than 0.2% of the total surface area of the calibration plane. Further, the entire surface area of each of the x-y regions may be irradiated by pivoting the scanner mirror by less than ±0.75°, preferably, less than ±0.6°, further preferably less than ±0.5° and in particular less than ±0.3° about an initial angular position defining a point of incidence of the radiation beam at the center of the x-y region.

The expression “angular basic position”, within the context of this application, defines the small range of angular positions, the scanner mirror may assume for irradiating one of the x-y regions. Each “angular basic position” may vary with an angular range of less than ±0.75°, preferably, less than ±0.6°, further preferably less than ±0.5° and in particular less than ±0.3° about an initial angular position defining a point of incidence of the radiation beam at the center of the x-y region. Thus, the variation of the “angular basic position” of the scanner mirror upon irradiating an x-y region typically is smaller than the angular difference between “first angular basic position” and the “second angular basic position”, i.e. the dimensions of the x-y regions in x-direction and y-direction typically are smaller than the distance between the centers of different x-y regions. Further, the x-y regions do not overlap.

In a step v), the first, the second, the third and the fourth calibration pattern are evaluated so as to determine focus positions of the radiation beam in the z-direction perpendicular to the calibration plane in dependence on an x-y position within the calibration plane. Finally, in a step vi), the irradiation system is calibrated based on the determined focus positions of the radiation beam. Preferably, the calibration is performed so as to optimize the focusing of the radiation beam in the irradiation plane onto which the radiation beam is incident during normal operation of the apparatus for producing a three-dimensional work piece. For example, the focus position of the radiation beam may be optimized in the calibration step vi) for an irradiation plane defined by a surface of the raw material powder layers which are selectively irradiated during operation of the apparatus for producing a three-dimensional work piece.

The method described herein thus allows the determination of not only a focus position in the z-direction perpendicular to the calibration plane, but also to associate different focus positions in the z-direction to different x-y positions within the calibration plane. For example, the evaluation of the calibration patterns may show that in the first x-y region the focus position is arranged closer to the scanner mirror than in the second x-y region or vice versa. A corresponding correction then may be calculated and the irradiation system may be calibrated while considering focus position variations both in the z-direction and within the x-y plane.

The calibration of the irradiation system in accordance with the method described herein may be carried out while a conventional focus offset compensation for correcting the focus offset in the z-direction due to the curved focal plane of the radiation beam deflected by the pivotable scanner mirror is performed, for example with the aid of flat field optics or by focus tracking. The calibration performed in step vi) then serves as a kind of fine adjustment of the focus position of the radiation beam in z-direction in dependence on an x-y position of a point of incidence of the radiation beam in the irradiation plane during operation of the apparatus for producing three-dimensional work pieces.

It is, however, also conceivable to carry out the method without any kind of focus offset compensation being performed or in place. The calibration performed in step vi) then includes the correction of the focus offset in the z-direction which is caused by the curved focal plane of the radiation beam deflected by the pivotable scanner mirror.

Basically, the calibration plane as arranged in one of steps i) or iii) may coincide with an irradiation plane onto which the radiation beam impinges during normal operation of the apparatus for producing a three-dimensional work piece. However, preferably the calibration in step vi) is performed so as to optimize the focusing of the radiation beam in the irradiation plane while taking into consideration the offset in the z-direction between the calibration plane(s) and the irradiation plane.

Steps ii) and iv) to vi) may be performed for a plurality of radiation beams. Thus, in case the irradiation system is designed in the form of a multi beam irradiation system, a corresponding plurality of calibration patterns may be irradiated by the plurality of radiation beams in each x-y region within the calibration plane. For that purpose, each x-y region may be subdivided into subregions, each subregion being associated with one of the plurality of radiation beams. The calibration patterns may be generated using the plurality of radiation beams either simultaneously or one after another.

Optical properties such as, for example, the refractive index of an optical fiber, a lens or another optical element of the irradiation unit or the geometry, in particular the curvature radius of a lens forming an optical element of the irradiation unit may change in dependence on the operating temperature of the irradiation unit. Typically, these temperature induced changes in the refractive index of the optical materials used for manufacturing the optical elements of the irradiation unit as well as temperature induced changes in the geometry, such as, for example, a curvature radius, of the optical elements of the irradiation unit lead to a shift of the focus position of the radiation beam emitted by the irradiation unit. Specifically, the focus position of the radiation beam, with increasing operating temperature of the irradiation unit, may be progressively shifted along the beam path of the radiation beam and hence in the z-direction perpendicular to the calibration plane.

Steps ii) and iv) to vi) may therefore be performed with the irradiation system having a plurality of different temperatures. Thus, a thermal focus shift may be determined and considered in steps v) and vi). For determining a temperature dependent thermal focus shift, each x-y region may be subdivided into subregions, each subregion being associated with one of the plurality of different temperatures. Basically, steps ii) and iv) to vi) may be performed with the irradiation system having only two different temperatures. For a more precise determination of the temperature dependent thermal focus shift, it is, however, preferable, to perform steps ii) and iv) to vi) with the irradiation system having more than two, e.g. six, different temperatures.

For changing the temperature of the irradiation system, the irradiation system, prior to performing steps ii) and iv) to vi), may be heated by irradiating a heating pattern in at least one heating region. The heating pattern may, for example, comprise 100 μm vectors which may be irradiated in cycles, for example 100 cycles. Further, the heating pattern may be irradiated at an irradiation speed of approximately 1 mm/s. The irradiation of the 100 μm vectors in 100 cycles at an irradiation speed of approximately 1 mm/s may result in an irradiation time of approximately 10 s of one heating pattern. The heating pattern may also be point-shaped, whereby the irradiation of the point-shaped heating pattern is carried out in a static deflection state of the radiation beam.

Preferably, one heating region which is irradiated in order to heat the irradiation system to a desired temperature is associated with each calibration pattern, i.e. a first heating region may be associated with the first calibration pattern, a second heating region may be associated with the second calibration pattern, a third heating region may be associated with the third calibration pattern, etc. On the one hand, each heating region should be arranged sufficiently far away from its associated calibration pattern that the calibration pattern is not affected by the heating process. For example, the heating region should be positioned relative to its associated calibration pattern such that the calibration pattern is not contaminated by smoke or other particulate impurities generated upon irradiating the heating pattern. However, on the other hand, each heating region should be arranged as close as possible to its associated calibration pattern in order to enhance the accuracy of the determination and consequently the compensation of the temperature and x-y position dependent thermal focus shift.

For example, the heating region may be arranged at a distance of approximately 2 mm in one of the x-direction or the y-direction from its associated calibration pattern. Alternatively or additionally, a region of the calibration plane which extends from the heating region in the other one of the x-direction or the y-direction should not be covered by the associated calibration pattern, i.e. should remain unirradiated in order to create a kind of “trail” or “corridor” for the removal of smoke or other particulate impurities generated upon irradiating the heating pattern.

The irradiation system may be set to a plurality of different temperatures by irradiating a plurality of heating patterns at a plurality of different output powers of the radiation beam emitted by the irradiation system. The operating temperature of the irradiation unit strongly depends on the output power of the radiation beam emitted by the irradiation unit. Therefore, a variation of the output power of the radiation beam emitted by the irradiation system is a reliable measure for varying the temperature of the irradiation system. For example, the plurality of heating patterns may be irradiated at different output powers of the radiation beam of 100 W, 200 W, 300 W, 400 W, 500 W and 600 W. In case the heating patterns are irradiated at different irradiation powers, an irradiation time preferably is maintained constant and set to, for example, 10 s.

The irradiation system may also be set to a plurality of different temperatures by irradiating a plurality of heating patterns with a plurality of different irradiation times. For example, the plurality of heating patterns may be irradiated with different irradiation times of 10 s, 12 s, 14 s, 16 s, 18 s and 20 s. In case the heating patterns are irradiated with different irradiation times, the output power of the radiation beam emitted by the irradiation unit preferably is maintained constant and set to, for example, 500 W.

It is, however, also conceivable to set the irradiation system to a plurality of different temperatures by irradiating a plurality of heating patterns at a plurality of different output powers of the radiation beam emitted by the irradiation system and with a plurality of different irradiation times. For example, for increasing the temperature of the irradiation system, the output power of the radiation beam emitted by the irradiation system and, simultaneously, the irradiation time may be increased in order to promote the heating of the irradiation system induced by the increase of the output power of the radiation beam emitted by the irradiation system.

Step iii) may be repeatedly performed so as to arrange the calibration plane at a plurality of further distances from the optical unit of the irradiation system. Each of the further distances may be different from the first and the second distance. A plurality of further calibration patterns may irradiated in the first and the second x-y region in accordance with step iv). The number of further calibration patterns irradiated in each of the first and the second x-y region preferably corresponds to the number of further distances at which the calibration plane is arranged from the optical unit of the irradiation system.

While the distance between the calibration plane and the optical unit of the irradiation system is maintained at at least one of the first, the second and the plurality of further distances, at least one additional calibration pattern may be irradiated in an additional x-y region within the calibration plane which is different from the first and the second x-y region. Preferably, a plurality of additional x-y regions may be defined within the calibration plane and irradiated so as to generate at least one additional calibration pattern in each of the additional x-y regions. The first, the second and the at least one additional x-y region may be distributed across the calibration plane so as to be able to determine the focus positions of the radiation beam in different spaced regions within the calibration plane.

Preferably, an additional calibration pattern is irradiated in the at least one additional x-y region within the calibration plane for each distance at which the calibration plane is arranged from the optical unit of the irradiation system. For example, the method may involve the arrangement of the calibration plane at 16 different distances from the optical unit of the irradiation system. Then, besides the first and the third calibration pattern, 14 further calibration patterns may be irradiated in the first x-y region. Similarly, besides the second and the fourth calibration pattern, 14 further calibration patterns may be irradiated in the second x-y region. The at least one additional x-y region then preferably is irradiated so as to generate 16 additional calibration patterns, each one of the 16 additional calibration patterns being associated with one of the distances at which the calibration plane is arranged from the optical unit of the irradiation system.

A typical distance between the calibration plane and the optical units is between 250 mm and 1000 mm, but can also be lower or higher in special cases.

In the second angular basic position the scanner mirror may be pivoted relative to the first angular basic position by at least ±2°, in particular by at least ±5°, preferably by at least ±10° and further preferably by at least ±15°. By increasing the angular difference between the “first angular basic position” and the “second angular basic position”, a distance between the centers of different x-y regions and consequently a surface area of the calibration plane which is taken into account in the calibration method may be increased.

Specifically, a distance between a center of the first x-y region and a center of the second x-y region within the calibration plane may correspond to at least 15 times, in particular at least 100 times, preferably at least 500 times and further preferably at least 1000 times the diameter of the focused radiation beam.

An x-y region can preferably have a size of at least 2 mm×2 mm, in particular at least 4 mm×4 mm and less than 40 mm×40 mm, in particular less than 25 mm×25 mm, preferably less than 12 mm×12 mm. This achieves a fast irradiation speed as well as good readability using common optical evaluation methods.

The calibration plane may be defined by a surface of or a plane within a raw material powder layer applied onto a carrier. It is, however, also conceivable that the calibration plane is defined by a surface of a burn-off film applied onto a carrier. The carrier accommodating the raw material powder layer or the burn-off film may be a specific calibration plate which is positioned in the beam path of the radiation beam during calibration of the irradiation system, but which is removed after the calibration process is completed. The calibration plate accommodating the raw material powder layer or the burn-off film may, for example, be a glass plate or an aluminum rod. A metal frame may be placed on the glass plate. The raw material powder layer or the burn-off film may however also applied onto a carrier which, during normal operation of an apparatus for producing a three-dimensional work piece accommodates the raw material powder layers to be selectively irradiated by the radiation beam emitted by the irradiation system. As a further alternative, the calibration plane may be defined by a surface of a calibration plate which is positioned in the beam path of the radiation beam during calibration of the irradiation system, but which is removed after completion of the calibration process.

In case the method for calibrating an irradiation system involves a heating of the irradiation system by irradiating a heating pattern in at least one heating region as described above, a burn-off film and/or a calibration plate preferably should be protected from undesired heating and in particular from heat induced damages. The burn-off film and/or the calibration plate, in an area of the at least one heating region, therefore may be provided with a through-hole allowing the radiation beam emitted by the irradiation system for heating the irradiation system to pass therethrough. The radiation beam may be caught by a radiation trap. For example, a metal frame placed on a calibration plate may serve as a radiation trap. The frame may be cooled, for example, water cooled, or may have a large heat capacity in order to prevent overheating of the frame.

The calibration patterns generated in the calibration plane, for example by irradiating a raw material powder layer, a burn-off film or a calibration plate may be detected by means of an optical detection device, in particular a camera. The optical detection device may record and hence detect the irradiation of the patterns already in situ, i.e. while the calibration patterns are irradiated on the calibration plane. Alternatively or additionally it is, however, also possible to use the optical detection device for recording the generated calibration patterns after the irradiation of the calibration patterns on the irradiation plane has been completed.

The optical detection device used for recording the calibration patterns may be an optical detection device which is already present in the apparatus for producing a three-dimensional work piece, for example for process monitoring purposes.

Especially in case the optical detection device is used for recording the completed calibration patterns, the optical detection device may, however, also be a conventional camera which may, for example, be employed in a hand-held microscope or even a mobile phone camera.

Further, a light-sensitive sensor arrangement positioned on or beneath the calibration plane may be used for detecting the calibration patterns. Again, the light-sensitive sensor arrangement may detect the irradiation of the patterns already in situ and/or after the irradiation of the calibration patterns on the calibration plane has been completed.

The calibration patterns may comprise at least one line. Line widths of the lines contained in the calibration patterns may be evaluated and the focus position of the radiation beam in the z-direction perpendicular to the calibration plane may be determined based on said evaluation of the widths of the lines of the calibration patterns. For example, the line widths of the lines contained in different calibration patterns generated in a selected x-y region of the calibration plane may be compared and the calibration pattern having the thinnest line may be determined as the calibration pattern which has been irradiated in the selected x-y region with the radiation beam being in focus. The calibration patterns may, however, also be evaluated using a gray scale analysis or another suitable image analysis for determining the focus position of the radiation beam in the z-direction.

In a preferred embodiment of the method for calibrating an irradiation system, at least one of the calibration patterns comprises a plurality of preferably substantially parallel lines. A line width or other suitable image analysis may then be performed for each of the lines and an average value may be calculated from the individual analysis values and used for the further evaluation procedure. The plurality lines may extend in a radial direction relative to an optical center of the irradiation system.

At least one of the calibration patterns may comprise a first block defined by a first plurality of substantially parallel lines and a second block defined by a second plurality of substantially parallel lines. The second plurality of substantially parallel lines of the second block may be arranged substantially perpendicular to the first plurality of substantially parallel lines of the first block. By evaluating blocks of lines extending substantially perpendicular to each other an optical astigmatism in the x-y plane, i.e. in the x-direction or the y-direction may be detected and considered upon calibrating the irradiation system.

The first plurality of substantially parallel lines of the first block may extend in a radial direction relative to an optical center of the irradiation system. The second plurality of substantially parallel lines of the second block then may extend perpendicular to a radial direction relative to the optical center of the irradiation system. Lines of a calibration pattern which extend in a radial direction relative to an optical center of the irradiation system and which are irradiated by a radiation beam with an optimized focus position across the calibration plane have a constant thickness across the calibration plane, since elliptical distorsions are avoided. A calibration pattern which comprises lines extending in a radial direction relative to an optical center of the irradiation system thus allows an additional determination of the beam diameter in dependence on the x-y position within the calibration plane.

An individual calibration pattern or a plurality of calibration patterns may be provided with an identification marker which is indicative of the position of the individual calibration pattern or the plurality of calibration patterns within the calibration plane. For example, a plurality of calibration patterns irradiated in a common x-y region within the calibration plane may be provided with a common identification marker. The identification marker may, for example, be a bar code or any other suitable marker which allows a localization of a position of the calibration patterns within the calibration plane. The identification marker may comprise one or more symbols, special characters or otherwise easy to identify marks, that could be easily recognized by an automatic image processing algorithm. The identification marker may comprise a code comprising information in data cells, particular binary data cells. The data cells may be formed as light and dark marks, as absent and present marks, as marks from different color and/or different shape. In a preferred embodiment the data cells are formed as line marks with different length, e.g. a short line represents the value “0”, and a long line represents the value “1”. The data cells, particularly lines, may be marked in a constant distance. A code of lines, variable in length and in same distance has proven to be robust in production as well as recognition. The presence of identification markers makes it possible to record and analyze partial regions of the calibration plane with a high accuracy while being able to localize the partial regions within the calibration plane with the aid of the identification markers.

Further, an individual calibration pattern or a plurality of calibration patterns may be surrounded by a line or another suitable geometric structure, such as a dashed line or a dotted line. The line may be straight or curved. The line may define a “box” accommodating the individual calibration pattern or the plurality of calibration patterns. The line may be used upon performing an evaluation algorithm and hence may simplify an automatic evaluation of the calibration pattern(s).

The irradiation positions of a plurality of calibration patterns irradiated in a common x-y region within the x-y region may be determined based upon an x-y offset of a point of incidence of the radiation beam on the calibration plane which is caused by the change of the distance between the calibration plane and the optical unit of the irradiation system in the z-direction. For example, the x-y offset may be compensated for upon calculating the irradiation positions of the calibration patterns in order to obtain calibration patterns which are aligned in the x-y plane independent of the change of the distance between the calibration plane and the optical unit in the z-direction during the calibration process. Such an approach may be useful when an in situ detection of the calibration patterns is envisaged. It is, however, also conceivable to refrain from compensating the x-y offset, but instead to use the x-y offset for generating calibration patterns which are arranged at a desired distance adjacent to each other. Such an approach may be advantageous in case the calibration patterns are recorded only after the irradiation of all calibration patterns on the irradiation plane has been completed.

The present disclosure also relates to a device for calibrating an irradiation system for use in an apparatus for producing a three-dimensional work piece by irradiating layers of a raw material powder with a radiation beam emitted by the irradiation system. The device comprises a control unit configured to:
i) set a distance between a calibration plane and an optical unit of the irradiation system in a z-direction perpendicular to the calibration plane to a first distance;
ii) while maintaining the distance between the calibration plane and the optical unit at the first distance, control the irradiation system so as to irradiate a first calibration pattern in a first x-y region within the calibration plane with a scanner mirror of the optical unit being arranged in a first angular basic position, and to irradiate a second calibration pattern in a second x-y region within the calibration plane with the scanner mirror of the optical unit being arranged at a second angular basic position in which the scanner mirror is pivoted relative to the first angular basic position by at least ±1°;
iii) set the distance between the calibration plane and the optical unit of the irradiation system in the z-direction perpendicular to the calibration plane to a second distance different from the first distance;
iv) while maintaining the distance between the calibration plane and the optical unit at the second distance, control the irradiation system so as to irradiate a third calibration pattern in the first x-y region within the calibration plane with the scanner mirror of the optical unit being arranged in the first angular basic position, and to irradiate a fourth calibration pattern in the second x-y region within the calibration plane with the scanner mirror of the optical unit being arranged in the second angular basic position in which the scanner mirror is pivoted relative to the first angular basic position by at least ±1°;
v) evaluate the first, the second, the third and the fourth calibration pattern so as to determine focus positions of the radiation beam in the z-direction perpendicular to the calibration plane in dependence on an x-y position within the calibration plane; and
vi) calibrate the irradiation system based on the determined focus positions of the radiation beam.

The control unit may further be configured to perform steps ii) and iv) to vi) for a plurality of radiation beams. Alternatively or additionally, the control unit may be configured to perform steps ii) and iv) to vi) with the irradiation system having a plurality of different temperatures.

For changing the temperature of the irradiation system, the control unit may be configured to heat the irradiation system, prior to performing steps ii) and iv) to vi), by irradiating a heating pattern in at least one heating region.

The control unit may be configured to set the irradiation system to a plurality of different temperatures by irradiating a plurality of heating patterns at a plurality of different irradiation powers and/or with a plurality of different irradiation times.

The control unit preferably is configured to perform step iii) repeatedly so as to arrange the calibration plane at a plurality of further distances from the optical unit of the irradiation system, each of the further distances being different from the first and the second distance. Further, the control unit may be configured to control the irradiation system so as to irradiate a plurality of further calibration patterns in the first and the second x-y region in accordance with step iv). The number of further calibration patterns irradiated in each of the first and the second x-y region may correspond to the number of further distances at which the calibration plane is arranged from the optical unit of the irradiation system.

The control unit may be configured to control the irradiation system so as to irradiate at least one additional calibration pattern in an additional x-y region within the calibration plane which is different from the first and the second x-y region, while the distance between the calibration plane and the optical unit is maintained fixed at at least one of the first, the second and the plurality of further distances.

The control unit may be configured to control the irradiation system such that the scanner mirror in the second angular basic position is pivoted relative to the first angular basic position by at least ±2°, in particular by at least ±5°, preferably by at least ±10° and further preferably by at least ±15°. Alternatively or additionally, the control unit may be configured to control the irradiation system such that a distance between a center of the first x-y region and a center of the second x-y region within the calibration plane corresponds to at least 15 times, in particular at least 100 times, preferably at least 500 times and further preferably at least 1000 times the diameter of the focused radiation beam.

The calibration plane may be defined by a surface of or a plane within a raw material powder layer applied onto a carrier, a surface of a burn-off film applied onto a carrier and/or a surface of a calibration plate. The burn-off film and/or the calibration plate, in an area of the at least one heating region, may be provided with a through-hole allowing the radiation beam emitted by the irradiation system for heating the irradiation system to pass therethrough. The device may also comprise a radiation trap which may be arranged in the beam path of the radiation beam downstream of the through hole.

The device may comprise one or more detection systems for detecting the calibration patterns. Specifically, the device may comprise an optical detection device configured to record the irradiation of the calibration patterns in situ, while the calibration patterns are irradiated on the calibration plane, and/or after the irradiation of the calibration patterns on the irradiation plane has been completed. Alternatively or additionally, the device may comprise a light-sensitive sensor arrangement positioned on or beneath the calibration plane.

The calibration patterns may comprise at least one straight line, curved line, dot or circle. The control unit may be configured to determine the focus position of the radiation beam in the z-direction perpendicular to the calibration plane in step v) based on an evaluation of a width of the lines, dots or circles of the calibration patterns.

At least one of the calibration patterns may comprise a first block defined by a first plurality of substantially parallel lines and a second block defined by a second plurality of substantially parallel lines. The second plurality of substantially parallel lines of the second block may be arranged substantially perpendicular to the first plurality of substantially parallel lines of the first block. The first plurality of substantially parallel lines of the first block may extend in a radial direction relative to an optical center of the irradiation system.

The control unit may be configured to control the irradiation system such that an individual calibration pattern or a plurality of calibration patterns, in particular a plurality of calibration patterns irradiated in a common x-y region within the calibration plane, is/are provided with an identification marker which is indicative of the position of the individual calibration pattern or the plurality of calibration patterns within the calibration plane.

The control unit may configured to determine irradiation positions of a plurality of calibration patterns irradiated in a common x-y region within the x-y region based upon an x-y offset of a point of incidence of the radiation beam on the calibration plane which is caused by the change of the distance between the calibration plane and the optical unit of the irradiation system in the z-direction.

A computer program product comprises program portions for performing the method as outlined according to any one or more of the example implementations as described throughout the present disclosure when the computer program product is executed on one or more computing devices.

An apparatus for producing a three-dimensional work piece by irradiating layers of a raw material powder with a radiation beam comprises an irradiation system according and an above-described device for calibrating the irradiation system and/or a computer-readable recording medium on which the above-described computer program product is stored.

Preferred embodiments of the invention will be described in greater detail with reference to the appended schematic drawings wherein

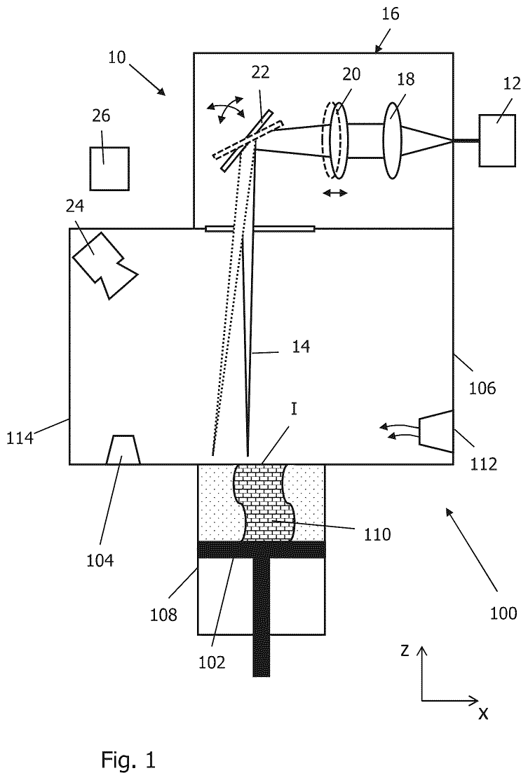

FIG. 1 shows an apparatus for producing a three-dimensional work piece by irradiating layers of a raw material powder with a radiation beam;

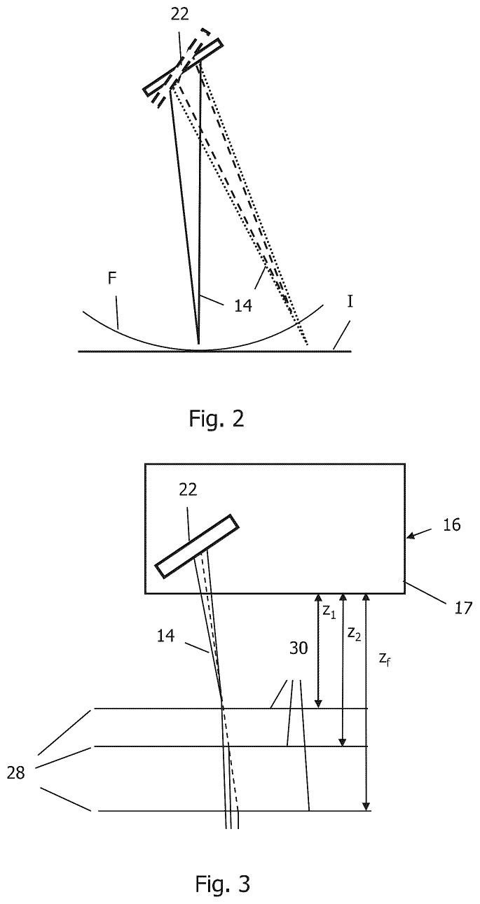

FIG. 2 shows a curved focal plane of a radiation beam deflected by a scanner mirror of an optical unit employed in the apparatus depicted in FIG. 1;

FIG. 3 shows an x-y offset of a point of incidence of a radiation beam on planes arranged at different distances from the optical unit in a z-direction perpendicular to a x-y plane;

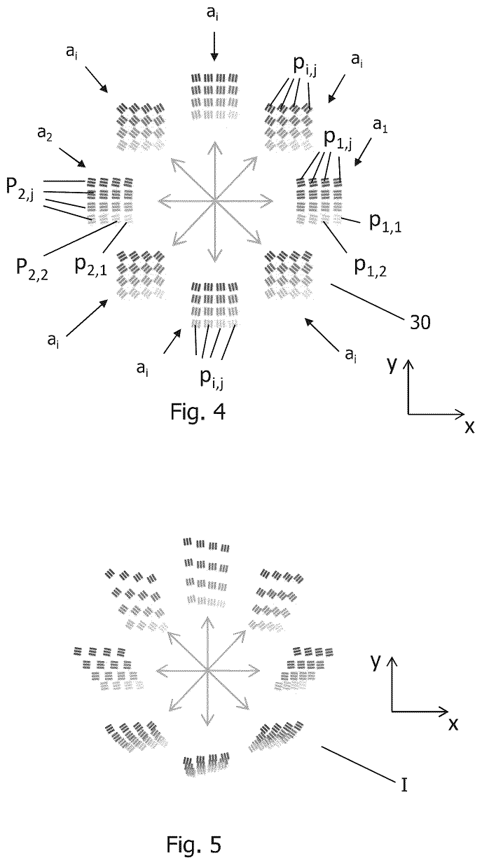

FIG. 4 shows an exemplary arrangement of calibration patterns suitable to be evaluated for calibrating the irradiation system of the apparatus depicted in FIG. 1;

FIG. 5 shows the calibration patterns of FIG. 4, however without compensation of the x-y offset as indicated in FIG. 3;

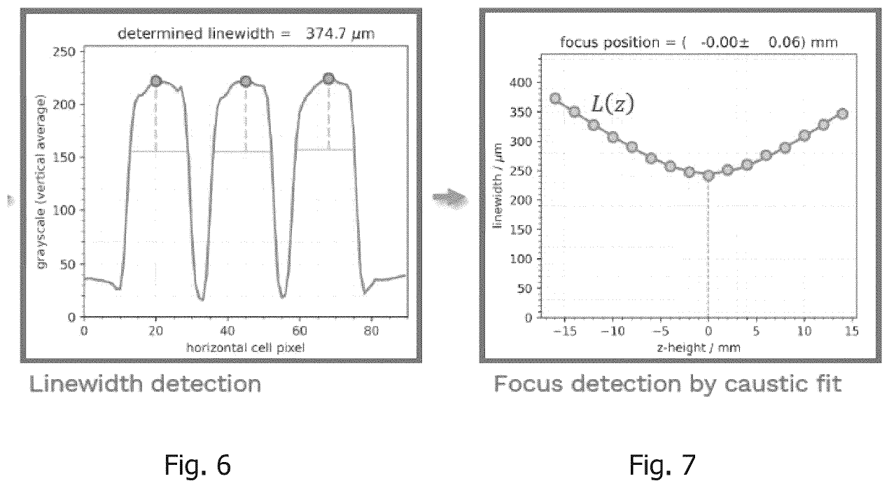

FIG. 6 shows a diagram for evaluating a width of lines of the calibration patterns shown in FIG. 4;

FIG. 7 shows a diagram for determining a focus position in z-direction using a caustic fit;

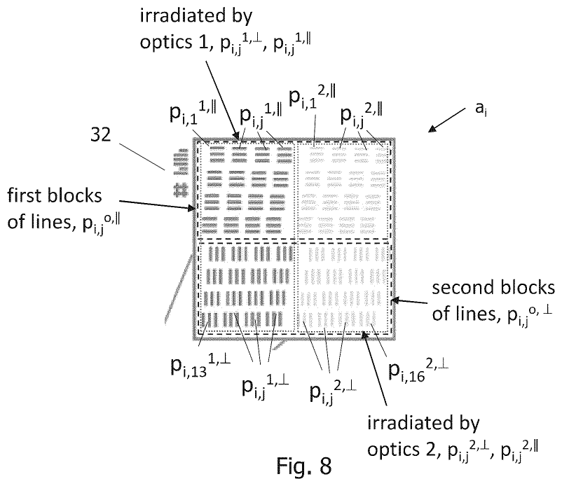

FIG. 8 shows a partial region of an alternative arrangement of calibration patterns suitable to be evaluated for calibrating an irradiation system emitting two radiation beams;

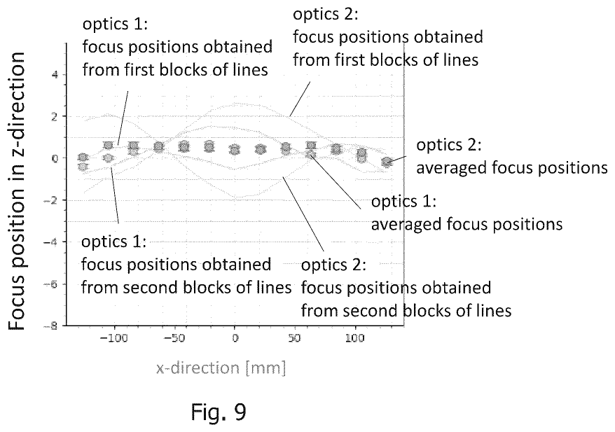

FIG. 9 shows a diagram indicating a focus position of two radiation beams in a z-direction perpendicular to a calibration plane in dependence on an x position within the calibration plane;

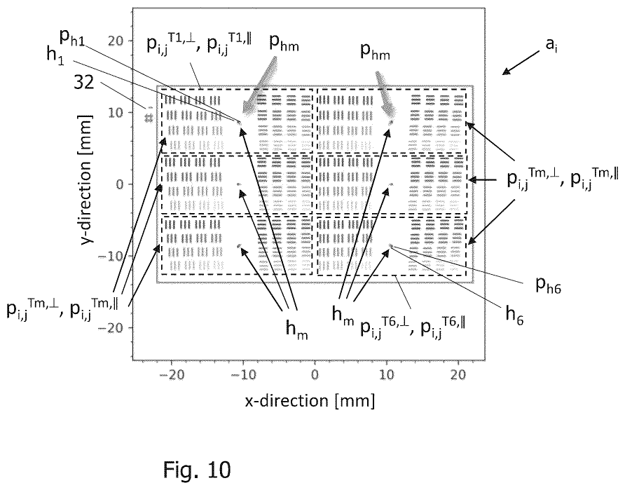

FIG. 10 shows a partial region of a further alternative arrangement of calibration patterns suitable to be evaluated for determining a thermal focus shift;

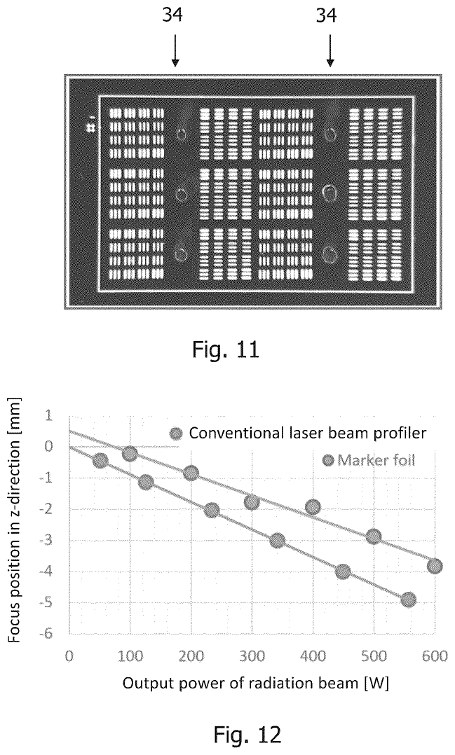

FIG. 11 shows a smartphone image of a burn-off film which may be used for analysing the calibration patterns shown in FIG. 10;

FIG. 12 shows a diagram indicating a focus position of a radiation beam in a z-direction perpendicular to a calibration plane in dependence on an output power of a radiation beam upon irradiating a heating pattern;

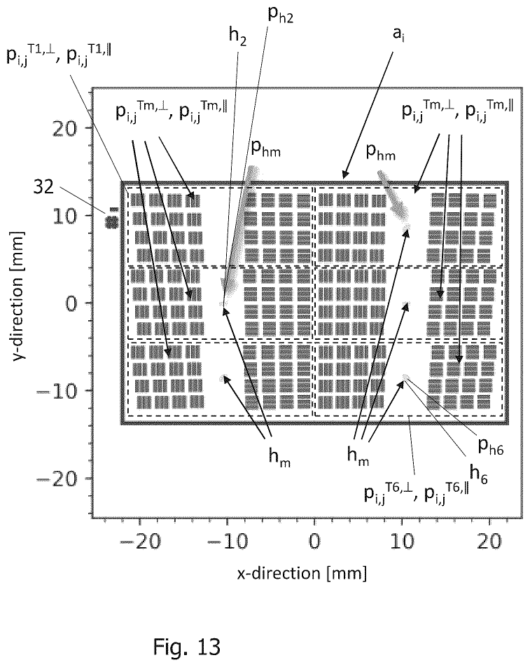

FIG. 13 shows a partial region of still a further alternative arrangement of calibration patterns suitable to be evaluated for determining a time dependent thermal focus shift;

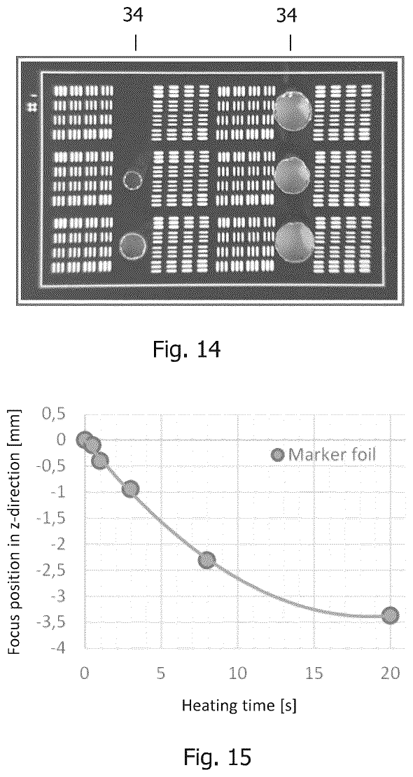

FIG. 14 shows a smartphone image of a burn-off film which may be used for analysing the calibration patterns shown in FIG. 13; and

FIG. 15 shows a diagram indicating a focus position of a radiation beam in a z-direction perpendicular to a calibration plane in dependence on a heating time.

FIG. 1 shows an apparatus 100 for producing a three-dimensional work piece by an additive manufacturing process. The apparatus 100 comprises a carrier 102 and a powder application device 104 for applying a raw material powder onto the carrier 102. The raw material powder may be a metallic powder, but may also be a ceramic powder or a plastic material powder or a powder containing different materials. The powder may have any suitable particle size or particle size distribution. It is, however, preferable to process powders of particle sizes <100 um. The carrier 102 and the powder application device 104 are accommodated within a process chamber 106 which is sealable against the ambient atmosphere. The carrier 102 is displaceable in a vertical direction into a built cylinder 108 so that the carrier 102 can be moved downwards with increasing construction height of a work piece 110, as it is built up in layers from the raw material powder on the carrier 12. The carrier 102 may comprise a heater and/or a cooler.

The apparatus 100 further comprises an irradiation system 10 for selectively irradiating laser radiation onto a raw material powder layer applied onto the carrier 102. In the embodiment of an apparatus 100 shown in FIG. 1, the irradiation system 10 comprises a radiation beam source 12 which is configured to emit a radiation beam 14. The radiation beam source 12 may be a laser beam source which is configured to emit a laser beam. An optical unit 16 for guiding and processing the radiation beam 14 emitted by the radiation beam source 12 is associated with the radiation beam source 12. It is, however, also conceivable that the irradiation system 10 is configured to emit two or more radiation beams.

The optical unit 16 comprises two lenses 18 and 20 which in the embodiment shown in FIG. 1 both have positive refractive power. The lens 18 is configured to collimate the laser light emitted by the radiation beam source 12, such that a collimated or substantially collimated radiation beam is generated. The lens 20 is configured to focus the collimated (or substantially collimated) radiation beam 14 on a desired position in a z-direction. The optical unit 16 further comprises a pivotable scanner mirror 22 which serves to deflect the radiation beam 14 and hence scan the radiation beam 14 in a x-direction and a y-direction across an irradiation plane I which, during operation of the apparatus 100 typically is defined by a surface of a raw material powder layer applied onto the carrier 102 so as to be selectively irradiated.

An optical detection device 24 which in the embodiment shown in FIG. 1 is designed in the form of a camera is arranged in the process chamber 16, for observing the radiation beam 14 and/or for observing irradiated regions after irradiation by the radiation beam 14. The optical detection device 24 may be part of a melt pool observation device, but also may be a separate device.

A control unit 26 is provided for controlling either exclusively the operation of the irradiation system 10 or also for controlling further components of the apparatus 100 such as, for example, the powder application device 104. The control unit 26 comprises a computer-readable recording medium on which a computer program product comprising program code portions is stored.

A controlled gas atmosphere, preferably an inert gas atmosphere is established within the process chamber 106 by supplying a shielding gas to the process chamber 106 via a process gas inlet 112. After being directed through the process chamber 106 and across the raw material powder layer applied onto the carrier 102, the gas is discharged from the process chamber 106 via a process gas outlet 114. The process gas may be recirculated from the process gas outlet 114 to the process gas inlet 112 and thereupon may be cooled or heated.

During operation of the apparatus 100 for producing a three-dimensional work piece, a layer of raw material powder is applied onto the carrier 102 by means of the powder application device 104. In order to apply the raw material powder layer, the powder application device 104 is moved across the carrier 102, e.g. under the control of the control unit 26. Then, again under the control of the control unit 26, the layer of raw material powder is selectively irradiated in accordance with a geometry of a corresponding layer of the work piece 110 to be produced by means of the irradiation device 10. The steps of applying a layer of raw material powder onto the carrier 102 and selectively irradiating the layer of raw material powder in accordance with a geometry of a corresponding layer of the work piece 110 to be produced are repeated until the work piece 110 has reached the desired shape and size.

The radiation beam 14 is scanned across the raw material powder layer according to a scanning pattern which is defined by the control unit 26. As shown in FIG. 2, the lens 20 is capable of focussing the radiation beam 14 onto the irradiation plane I in case the pivotable scanner mirror 22 is arranged in such an angular position that the radiation beam 14 is incident on the irradiation plane I in a direction perpendicular to the irradiation plane I, i.e. in case a beam axis of the radiation beam 14 is parallel to the z-direction.

However, in case the scanner mirror 22 is pivoted so as to deflect the radiation beam 14 in such a manner that the beam axis of the radiation beam 14 no longer extends perpendicular to the irradiation plane I, the length of the beam path is increased and hence the focus position of the radiation beam 14 as indicated in dashed lines in FIG. 2 no longer is arranged in the irradiation plane I, but offset in the z-direction to a position above the irradiation plane I. Specifically, the focus positions of the radiation beams 14 deflected by the pivotable scanner mirror 22 define a curved focal plane F, whereas the irradiation plane I typically is flat. Thus, the focus offset in the z-direction depends on a pivot angle of the scanner mirror 22 and hence on an irradiation position within the irradiation plane I, i.e. an x-y position at which the radiation beam 14 impinges on the irradiation plane I.

In the apparatus 100, the focus offset of the radiation beam 14 in the z-direction therefore is corrected as shown by the dotted lines in FIGS. 1 and 2, for example with the aid of flat field optics or by focus tracking using a suitably adjustable optical element (not shown in the drawings). However, the focus offset compensation that is achieved by these conventional compensation means does not consider any x-y position dependencies of the focus position that are not related to the increase of the beam path length due to the deflection of the radiation beam 14 by the pivotable scanner mirror 22. In order to allow a more accurate correction of the focus position of the radiation beam 14, in the apparatus 100, the irradiation system 10 therefore is calibrated as will be discussed in detail below.

For calibrating the irradiation system 10 of the apparatus 100, a calibration plate 28 is introduced into the beam path of the radiation beam 14 as schematically illustrated in FIG. 3 such that a surface of the calibration plate 28 extends parallel to the irradiation plane I onto which the radiation beam 14 impinges during normal operation of the apparatus 100. In particular, the calibration plate 28 is placed on a surface of the carrier 102 which during normal operation of the apparatus 100 accommodates the raw material powder and the work piece 110. A surface of the calibration plate 28 defines a calibration plane 30 onto which calibration patterns are irradiated as described further below.

Alternatively to the use of a calibration plate 28, a burn-off film may be applied to either a calibration plate or the carrier 102 for detecting and recording calibration patterns irradiated onto a calibration plane which then is defined by a surface of the burn-off film. As a further alternative, a raw material powder layer may be applied onto the carrier 102 and a surface of or a plane within the raw material powder layer may define a calibration plane onto which the calibration patterns are irradiated.

In the apparatus 100, the optical detection device 24 is used for recording the irradiation of the calibration patterns in situ while the calibration patterns are irradiated on the calibration plane 30 defined by the surface of the calibration plate 28. It is, however, also conceivable to use the optical detection device 24 for recording and detecting calibration patterns only after completion of the irradiation of the calibration patterns onto a calibration plane. For example, the optical detection device 24 may take a picture of a burn-off film after being irradiated in order to detect the calibration patterns irradiated onto the surface of the burn-off film.

Further, the calibration plate 28 may be provided with a light-sensitive sensor arrangement which may be embedded within the calibration plate 28 and hence arranged beneath the calibration plane 30 or which may be arranged on the calibration plane 30. The light-sensitive sensor arrangement may be capable of detecting and recording a calibration pattern irradiated onto the calibration plane 30 either in situ and/or after the irradiation of the calibration patterns has been completed.

In a step i) of a method for calibrating the irradiation system 10, a distance between the calibration plane 30 and the optical unit 16 of the irradiation system 10 in a z-direction perpendicular to the calibration plane 30 is set to a first distance z₁ as shown in FIG. 3. For example, the first distance z₁ may be measured between the calibration plane 30 and a housing 17 of the optical unit 16. This is achieved by appropriately moving the carrier 102 with the calibration plate 28 placed thereon in the z-direction until the surface of the calibration plate 28 which defines the calibration plane 30 is arranged at the first distance z₁ from the optical unit 16.

Thereafter, in a step ii), while the distance between the calibration plane 30 and the optical unit 16 is maintained at the first distance z₁, a first calibration pattern _{p1,1} is irradiated in a first x-y region a₁ within the calibration plane 30. In the following the reference sign “aᵢ” is used for designating x-y regions within the calibration plane 30 which are irradiated so as to generate a calibration pattern “p_{i,j}”. Upon irradiating the first calibration pattern p_{1,1} the scanner mirror 22 is arranged in a first angular basic position. After the irradiation of the first calibration pattern p_{1,1} is completed, the scanner mirror 22 is pivoted relative to the first angular basic position by at least ±1°, in particular by at least ±2°, specifically by at least ±5°, preferably by at least ±10° and further preferably by at least ±15° into a second angular basic position. Thereafter, a second calibration pattern p_{2,1} is irradiated in a second x-y region a₂ within the calibration plane 30, while the scanner mirror remains in the second angular basic position.

The pivoting movement of the scanner 22 by at least ±1° ensures that the first and the second x-y region a₁, a₂ are sufficiently spaced from each other within the calibration plane 30. In particular, a distance between a center of the first x-y region a₁ and a center of the second x-y region a₂ within the calibration plane 30 corresponds to at least 15 times, in particular at least 100 times, preferably at least 500 times and further preferably at least 1000 times the diameter of the focused radiation beam 14. Such a selection of the distance between the center of the first x-y region a₁ and the center of the second x-y region a₂ is, e.g., suitable if the diameter of the focused radiation beam 14 is ≤approximately 300 μm.

Then, in a step iii), the distance between the calibration plane 30 and the optical unit 16 of the irradiation system 10 in the z-direction perpendicular to the calibration plane is set to a second distance z₂ different from the first distance z₁. For example, as shown in FIG. 3, the calibration plate 28 may be displaced in the z-direction by moving the carrier 102 downwards in the vertical direction so as to increase the distance between the calibration plane 30 and the optical unit 16 from the first distance z₁ to the second distance z₂.

While maintaining the distance between the calibration plane 30 and the optical unit 16 at the second distance z₂, in a step iv), a third calibration pattern p_{1,2} is irradiated in the first x-y region a₁ within the calibration plane 30 with the scanner mirror 22 again being arranged in the first angular basic position. After completion of the irradiation of the third calibration pattern p_{1,2}, the scanner mirror 22 is pivoted again relative to the first angular basic position by at least ±1°, in particular by at least ±2°, specifically by at least ±5°, preferably by at least ±10° and further preferably by at least ±15° into the second angular basic position and a fourth calibration pattern p_{2,2} is irradiated in the second x-y region a₂ within the calibration plane 30 with the scanner mirror 22 being arranged in the second angular basic position.

Step iii) is repeatedly performed so as to arrange the calibration plane 30 at a plurality of further distances z_{f} from the optical unit 16 of the irradiation system 10, wherein each of the further distances z_{f} is different from the first and the second distance z₁, z₂. A plurality of further calibration patterns p_{1,j}, p_{2,j} are irradiated in the first and the second x-y region a₁, a₂ in accordance with step iv), wherein the number of further calibration patterns p_{1,j}, p_{2,j} irradiated in each of the first and the second x-y region a₁, a₂ corresponds to the number of further distances z_{f} at which the calibration plane 30 is arranged from the optical unit 16 of the irradiation system 10. For example, in order to generate the exemplary arrangement of calibration patterns shown in FIG. 4, the calibration plane 30 is arranged at 16 different distances from the optical unit 16 and a total of 16 calibration patterns are irradiated in each of the first and the second x-y region a₁, a₂.

Further, while the distance between the calibration plane 30 and the optical unit 16 is maintained at the first, the second and the plurality of further distances z₁, z₂, z_{f}, additional calibration patterns p_{i,j} are irradiated in additional x-y regions a₁ within the calibration plane 30 which are different from the first and the second x-y region a₁, a₂. In the exemplary arrangement of calibration patterns shown in FIG. 4, 6 additional x-y regions aᵢ are defined within the calibration plane 30 and each of the additional x-y regions aᵢ is irradiated with an additional calibration pattern p_{i,j} for each of the different distances at which the calibration plane 30 is arranged from the optical unit 16.

It is not necessarily required that the scanner mirror 22 is pivoted by at least ±1° for irradiating all adjacent additional x-y regions aᵢ. Instead, the method may also be performed with only the first and the second x-y region a₁, a₂ being spaced from each other such that a pivoting movement of the scanner mirror 22 by at least ±1° is necessary for irradiating the first and the second x-y region a₁, a₂, whereas additional x-y regions aᵢ may be arranged closer to each other and/or to the first and the second x-y region a₁, a₂. However, the x-y region a₁, a₂, aᵢ which are defined in the calibration plane 30 should not overlap. Further, the x-y region a₁, a₂, aᵢ preferably are distributed across the calibration plane 30 as shown, for example, in FIG. 4.

While being arranged in in its first, second and any further angular basic positions, the scanner mirror 22 slightly pivots, for irradiating the desired calibration patterns p_{1,1}, p_{1,2}, p_{1,j}. However, upon irradiating an x-y region a₁, a₂, aᵢ, the pivoting movement of the scanner mirror 22 about an initial angular position defining a point of incidence of the radiation beam 14 at the center of the x-y region a₁, a₂, aᵢ be irradiated is limited to less than ±0.75°, preferably, less than ±0.6°, further preferably less than ±0.5° and in particular less than ±0.3°. Thus, as compared to the total calibration plane 30 each of the x-y regions a₁, a₂, aᵢ is small and has a surface area that is less than 5%, preferably less than 1%, further preferably less than 0.5% and in particular less than 0.2% of the total surface area of the calibration plane 30.

In the exemplary calibration pattern arrangement according to FIG. 4, each of the calibration patterns p_{1,1}, p_{2,1}, p_{1,2}, p_{2,2}, p_{1,j}, P_{2,j}, P_{i,j} comprises three parallel lines which extend in a radial direction relative to an optical center of the irradiation system 10. The evaluation of a plurality of lines renders the calibration method more reliable and reduces the risk of measurement errors, since errors occurring upon irradiation or the presence of impurities can be compensated for. Further, the irradiation positions of calibration patterns p_{1,1}, p_{2,1}, p_{1,2}, p_{2,2}, p_{1,j}, p_{2,j}, p_{i,j} which are irradiated in a common x-y region a₁, a₂, aᵢ are determined based upon an x-y offset of a point of incidence of the radiation beam 14 on the calibration plane 30 which is caused by the displacement of the calibration plane 30 in the z-direction as shown in FIG. 3. Thus, in the calibration plane 30 the calibration patterns p_{1,1}, p_{2,1}, p_{1,2}, p_{2,2}, p_{1,j}, p_{2,j}, p_{i,j} are arranged adjacent to each other, whereas, in the irradiation plane I, which is not moved in z-direction, the calibration patterns p_{1,1}, p_{2,1}, p_{1,2}, p_{2,2}, p_{1,j}, p_{2,j}, p_{i,j} appear distorted as shown in FIG. 5. The control unit 26, however, it is capable of performing a transformation calculation for correcting the x-y offset such that the appearance of the calibration patterns p_{1,1}, p_{2,1}, p_{1,2}, p_{2,2}, p_{i,j}, P_{2,j}, p_{i,j} in the irradiation plane I can be transformed into the appearance of the calibration patterns p_{1,1}, p_{2,1}, p_{1,2}, p_{2,2}, p_{1,j}, p_{2,j}, p_{i,j} in the calibration plane 30 and vice versa.

In a step v), the first, the second, the third, the fourth and the further calibration patterns p_{1,1}, p_{2,1}, p_{1,2}, p_{2,2}, p_{1,j}, p_{2,j}, p_{i,j} are evaluated by the control unit 26 so as to determine focus positions of the radiation beam 14 in the z-direction perpendicular to the calibration plane 30 in dependence on an x-y position within the calibration plane 30. In particular, the control unit 26 determines the focus position of the radiation beam 14 in the z-direction based on an evaluation of a width of the lines of the calibration patterns p_{1,1}, p_{2,1}, p_{1,2}, p_{2,2}, p_{1,j}, p_{2,j}, p_{i,j}. As shown in FIG. 6, a line width analysis is performed for each of the lines of a selected calibration pattern p_{1,1}, p_{2,1}, p_{1,2}, p_{2,2}, p_{1,j}, p_{2,j}, p_{i,j} and an average value is calculated from the individual analysis values and used for the further evaluation procedure.

As shown in FIG. 7, the line width values of the calibration patterns p_{1,1}, p_{2,1}, p_{1,2}, p_{2,2}, p_{1,j}, p_{2,j}, p_{i,j} generated within a selected x-y region a₁, a₂, aᵢ are plotted against the z-position, i.e. the position of the calibration plane 30 along the z-direction, and the calibration pattern p_{1,1}, p_{2,1}, p_{1,2}, p_{2,2}, p_{1,j}, p_{2,j}, p_{i,j} having the thinnest line is determined as the calibration pattern p_{1,1}, p_{2,1}, p_{1,2}, p_{2,2}, p_{1,j}, p_{2,j}, p_{i,j} which has been irradiated in the selected x-y region a₁, a₂, aᵢ with the radiation beam 14 being in focus. It is, however, also conceivable to determine the focus position using a fit of a function corresponding to a Gaussian beam profile. The analysis shown in FIG. 7 is repeated for all x-y regions a₁, a₂, aᵢ defined on the calibration plane 30. As a result, the focus position of the radiation beam 14 in z-direction in dependence on an x-y position within the calibration plane 30 is obtained.

Finally, in a step vi), the irradiation system 10 is calibrated based on the determined focus positions of the radiation beam 14. In particular, the calibration is performed so as to optimize the focusing of the radiation beam 14 in the irradiation plane I onto which the radiation beam 14 is incident during normal operation of the apparatus 100 for producing a three-dimensional work piece 110.

Steps ii) and iv) to vi) as described above may also be performed for a plurality of radiation beams 14. For example, calibration patterns p_{i,j}^{0,∥}, p_{i,j}^{o,⊥} generated within a selected x-y region aᵢ may be generated by each of a plurality of radiation beams 14, wherein “o” designates the optical unit emitting a selected one of the radiation beams 14, and wherein signs ∥ and ⊥ designate an orientation of the lines defining the calibration patterns p_{i,j}^{o,∥}, p_{i,j}^{o⊥}0. FIG. 8 shows an exemplary x-y region aᵢ, wherein calibration patterns p_{i,j}^{1,|}, p_{i,j}^{1,⊥}, pᵢⱼ^{2,∥}, p_{i,j}^{2,⊥} are generated by two radiation beams 14. In particular, the x-y region aᵢ shown in FIG. 8, is subdivided into two subregions, each subregion being associated with one of the two radiation beams 14. The calibration patterns p_{i,j}^{1,∥}, p_{i,j}^{1,⊥} in a left-hand portion of the x-y region aᵢ (first subregion being encircled by the left dotted rectangle) are generated by a first radiation beam 14 with the aid of a first optical unit 16, whereas the calibration patterns p_{i,j}^{2,∥}, p_{i,j}^{2,⊥} in a right-hand portion of the x-y region aᵢ (second subregion being encircled by the right dotted rectangle) are generated by a second radiation beam 14 with the aid of a second optical unit 16.

Each of the calibration patterns p_{i,j}^{o,∥}, p_{i,j}^{o,⊥} comprises at least one first block p_{i,j}^{o,∥}defined by, for example, three substantially parallel lines and at least one second block p_{i,j}^{o,⊥} defined by, for example, three substantially parallel lines, wherein the lines of the second block p_{i,j}^{o,⊥} are arranged substantially perpendicular to the lines of the first block p_{i,j}^{o, ∥}. Specifically, each of the calibration patterns p_{i,j}^{o,∥}, p_{i,j}^{o,⊥} comprises a plurality of, here 16, first blocks p_{i,j}^{o,∥}, each being defined by three substantially parallel lines and a plurality of, here 16, second blocks p_{i,j}^{o,⊥}, each being defined by three substantially parallel lines, wherein the lines of the second blocks p_{i,j}^{o,⊥} are arranged substantially perpendicular to the lines of the first blocks p_{i,j}^{o,∥}. In FIG. 8, the plurality of first blocks p_{i,j}^{o,∥} is arranged in an upper portion of the x-y region aᵢ and encircled by the upper dashed rectangle, while the plurality of second blocks p_{i,j}^{o,⊥} is arranged in a lower portion of the x-y region aᵢ and encircled by the lower dashed rectangle.

The calibration patterns p_{i,j}^{o,∥}, p_{i,j}^{o,⊥} which are irradiated in the common x-y region aᵢ are provided with an identification marker 32 which is indicative of the position of the calibration patterns p_{i,j}^{o,∥}, p_{i,j}^{o,⊥} within the calibration plane 30. The identification marker 32 may, for example, be a bar code which allows a localization of a position of the calibration patterns p_{i,j}^{o,∥}, p_{i,j}^{o,⊥} within the calibration plane 30 and hence makes it possible to record and analyze partial regions of the calibration plane 30 with a high accuracy.

Although the provision of an identification marker 32 is described herein with reference to FIG. 8 showing calibration patterns generated by more than one radiation beam 14, identification markers 32 can also be used for marking calibration patterns p_{i,j} which are generated by a single radiation beam 14. For example, also one or more of the calibration patterns p_{i,j} shown in FIG. 4 may be marked by an identification marker.

FIG. 9 shows a diagram wherein the focus positions of the radiation beams 14 used for generating calibration patterns p_{i,j}^{o,∥}, p_{i,j}^{o,⊥} as shown in FIG. 8 for the exemplary x-y region aᵢ in z-direction are plotted against the x-direction. A corresponding diagram can also be plotted for the y-direction. Further, it is, of course, also possible to plot the focus positions against an x-y-plane.

The curves shown in the diagram of FIG. 9 are obtained by evaluating either the first or the second block of lines which extend perpendicular to each other. With given lens positions within the optical units 16 and moving scanner mirrors 22, the astigmatic axes are constant across the x-y plane. However, the line patterns rotate such that the radially extending lines are directed towards the irradiating optical unit. Consequently, the result of a measurement across the x-y plane is an oscillating wave pattern of the astigmatic focus positions as a function of the x-y position. A large discrepancy between the focus positions determined for the different blocks of lines indicates an astigmatism of the optics used for generating a radiation beam 14. The actual astigmatism, i.e. the distance between the focus positions of both beam axes may be measured at a maximum of the oscillation. The dots in the diagram indicate the averaged focus position values which are determined by averaging the values obtained for the first and the second blocks of lines. The arrangement of the dots in the diagram shows that the focus position at the edges of the calibration plane 30 is shifted to a somewhat smaller distance from the optical unit 16. This focus position shift can be corrected by the calibration performed in step vi) in order to obtain an even focus position distribution across the irradiation plane I.

Steps ii) and iv) to vi) as described above may also be performed with the irradiation system 10 having a plurality of different temperatures Tm. Thus, a thermal focus shift may be determined and considered in steps v) and vi). FIG. 10 shows an exemplary x-y region aᵢ, wherein calibration patterns p_{i,j}^{Tm,∥}, p_{i,j}^{TM,⊥} are generated with the irradiations system being set at six different temperatures Tm=T1, . . . ,T6. In particular, the x-y region aᵢ of FIG. 10 is subdivided into six subregions, each subregion being associated with one of the plurality of (six) different temperatures Tm. In FIG. 10, each subregion is encircled by a dashed rectangle.

Similar to the arrangement shown in FIG. 8, each of calibration patterns p_{i,j}^{Tm,∥}, p_{i,j}^{Tm,⊥} in the x-y region ai according to FIG. 10 comprises at least one first block p_{i,j}^{Tm,∥} defined by, for example, three substantially parallel lines and at least one second block p_{i,j}^{Tm,⊥} defined by, for example, three substantially parallel lines, wherein the lines of the second block p_{i,j}^{Tm,⊥} are arranged substantially perpendicular to the lines of the first block p_{i,j}^{Tm,∥}. Specifically, each of the calibration patterns pᵢⱼ^{Tm,∥}, p_{i,j}^{Tm,⊥} comprises a plurality of, here 16, first blocks p_{i,j}^{Tm,∥}, each being defined by three substantially parallel lines and a plurality of, here 16, second blocks p_{i,j}^{Tm,⊥}, each being defined by three substantially parallel lines, wherein the lines of the second blocks p_{i,j}^{Tm,⊥} are arranged substantially perpendicular to the lines of the first blocks p_{i,j}^{Tm,∥}. Also similar to the arrangement shown in FIG. 8, an identification marker 32 is provided which is indicative of the position of the calibration patterns. p_{i,j}^{Tm,∥}, p_{i,j}^{Tm,⊥} within the calibration plane 30.

For changing the temperature of the irradiation system 10, the irradiation system 10, prior to performing steps ii) and iv) to vi), is heated by irradiating a heating pattern pₕₘ in at least one heating region hₘ. In the exemplary arrangement of FIG. 10, one heating region hₘ is associated with each of the calibration patterns p_{i,j}^{Tm,∥}, p_{i,j}^{Tm,⊥}. Each heating region hₘ is arranged sufficiently far away from its associated calibration pattern p_{i,j}^{Tm,∥}, p_{i,j}^{Tm,⊥}, i.e. each of the first block p_{i,j}^{Tm,∥} and the second block p_{i,j}^{Tm,⊥} of the respective calibration pattern p_{i,j}^{Tm,∥}, p_{i,j}^{Tm,⊥}, that the calibration pattern p_{i,j}^{Tm,∥}, p_{i,j}^{Tm,⊥} is not affected by the heating process. Specifically, each heating region hₘ is arranged at a distance of approximately 2 mm in the x-direction from each of the first block p_{i,j}^{Tm,∥} and the second block p_{i,j}^{Tm,⊥} of the respective calibration pattern p_{i,j}^{Tm,∥}, p_{i,j}^{Tm,⊥}. In addition, a region of the calibration plane 30 which extends from the heating region hₘ in the y-direction should is covered by the associated calibration pattern p_{i,j}^{Tm,∥}, p_{i,j}^{Tm,⊥}, i.e. remains unirradiated in order to create a kind of “trail” or “corridor” for the removal of smoke or other particulate impurities generated upon irradiating the heating pattern pₕₘ. At the same time, each heating region hm is arranged sufficiently close to its associated calibration pattern p_{i,j}^{Tm,∥}, p_{i,j}^{Tm,⊥} that the temperature dependent thermal focus shift can be determined with the desired accuracy.

The heating pattern pₕₘ comprises 100 μm vectors which are irradiated in 100 cycles at an irradiation speed of approximately 1 mm/s. In order to protect a burn-off film and/or a calibration plate for defining the calibration plane 30 from undesired heating and in particular from heat induced damages, the burn-off film and/or the calibration plate, in an area of the heating regions hₘ is provided with a through-hole allowing the radiation beam 14 emitted by the irradiation system 10 for heating the irradiation system 10 to pass therethrough. The radiation beam 14 may be caught by a radiation trap.

The operating temperature of the irradiation unit 10 strongly depends on an output power of the radiation beam 14 emitted by the irradiation unit 10. In the arrangement of FIG. 10, the irradiation system 10 is set to the plurality of different temperatures Tm by irradiating the plurality of heating patterns pₕₘ at a plurality of different output powers of the radiation beam 14 emitted by the irradiation system 10. In particular, the plurality of heating patterns pₕ₁ to pₕ₆ is irradiated at different output powers of the radiation beam 14 of 100 W, 200 W, 300 W, 400 W, 500 W and 600 W in order to heat the irradiation system 10 to the six different temperatures T1 to T6. An irradiation time tm is maintained constant and set to 10 s.

A smartphone image of a burn-off film which may be used for evaluating the calibration patterns p_{i,j}^{Tm,∥}, p_{i,j}^{Tm,⊥} of FIG. 10 is shown in FIG. 11. In the image of FIG. 11, the line widths of the lines contained in the calibration patterns p_{i,j}^{Tm,∥}, p_{i,j}^{Tm,⊥} may be evaluated and the focus position of the radiation beam 14 in the z-direction perpendicular to the calibration plane 30 may be determined based on said evaluation of the widths of the lines of the calibration patterns p_{i,j}^{Tm,∥}, p_{i,j}^{Tm,⊥}. In particular, for each heating region hₘ, the line widths of the lines contained in associated calibration patterns p_{i,j}^{Tm,∥}, p_{i,j}^{Tm,⊥} may be compared and the calibration pattern p_{i,j}^{Tm,∥}, p_{i,j}^{Tm,⊥} having the thinnest line may be determined as the calibration pattern p_{i,j}^{Tm,∥}, p_{i,j}^{Tm,⊥} which has been irradiated with the radiation beam 14 being in focus. The image of FIG. 11 also shows that the through holes 34 which are provided in the burn-off film in the heating regions hₘ are enlarged during irradiating the burn-off film, wherein the enlargement of the through holes 32 increases with increasing output powers of the radiation beam 14.

The diagram of FIG. 12 is obtained from the evaluation of the image shown in FIG. 11 and indicates a focus position of the radiation beam 14 in a z-direction perpendicular to the calibration plane 30 in dependence on the output power of the radiation beam 14 upon irradiating the heating patterns pₕₘ. In other words, the diagram of FIG. 12 illustrates the thermal focus shift in dependence on the temperature Tm of the irradiation system 10. This thermally induced shift of the focus position can be corrected by the calibration performed in step vi) in order to obtain an even focus position distribution across the irradiation plane I.

The lower curve shown in the diagram of FIG. 12 is obtained by conventional caustic measurements, whereas the upper curve in the diagram of FIG. 12 is obtained by evaluating the line widths of the calibration patterns p_{i,j}^{Tm,∥}, p_{i,j}^{Tm,⊥} in the image of FIG. 11. FIG. 12 indicates that the evaluation of the line widths of the calibration patterns p_{i,j}^{Tm,∥}, p_{i,j}^{Tm,⊥} allows the determination of the thermal focus shift with a reasonable accuracy although the evaluation of the line widths of the calibration patterns p_{i,j}^{Tm,∥}, p_{i,j}^{Tm,⊥} is cheaper, quicker and automatable as compared to caustic measurements that require specific measurement devices, trained personal and machine downtimes.

Further, focus positions obtained by evaluating the first blocks p_{i,j}^{Tm,∥} and focus positions obtained by evaluating the second blocks p_{i,j}^{Tm,⊥} can be compared as described above with reference to FIG. 9 for determining an astigmatism of the optics used for generating the radiation beam 14. Again, also this focus position shift can be corrected by the calibration performed in step vi) in order to obtain an even focus position distribution across the irradiation plane I.

The arrangement of FIG. 13 differs from the arrangement of FIG. 10 in that the irradiation system is heated to six different temperatures Tm=T1, . . . ,T6 by irradiating the plurality of heating patterns pₕₘ with a plurality of different irradiation times, i.e. heating times tm. In particular, the plurality of heating patterns pₕ₁ to pₕ₆ is irradiated with different irradiation times, i.e. heating times of 0 s, 0,5 s, 1 s, 3 s, 8 s and 20 s, while the output power of the radiation beam 14 emitted by the irradiation unit 10 is maintained constant and set to 500 W. The heating pattern pₕₘ again comprises 100 μm vectors which are irradiated in 100 cycles at an irradiation speed of approximately 1 mm/s. Otherwise the arrangement of FIG. 13 corresponds to the arrangement of FIG. 10.

FIG. 14 shows a smartphone image of a burn-off film which may be used for evaluating the calibration patterns p_{i,j}^{Tm,∥}, p_{i,j}^{Tm,⊥} of FIG. 13. As described with reference to FIGS. 10 and 11 above, in the image of FIG. 14, the line widths of the lines contained in the calibration patterns p_{i,j}^{Tm,∥}, p_{i,j}^{Tm,⊥} may be evaluated and the focus position of the radiation beam 14 in the z-direction perpendicular to the calibration plane 30 may be determined based on said evaluation of the widths of the lines of the calibration patterns p_{i,j}^{Tm,∥}, p_{i,j}^{Tm,⊥}. The image of FIG. 14 also shows that the through holes 34 which are provided in the burn-off film in the heating regions hₘ are enlarged during irradiating the burn-off film, wherein the enlargement of the through holes 32 increases with increasing heating time. No through hole is provided in the heating region h₁, since in the heating region h₁, the heating time is 0 s.

FIG. 15 shows a diagram which is obtained from the evaluation of the image shown in FIG. 14 and indicates a focus position of the radiation beam 14 in a z-direction perpendicular to the calibration plane 30 in dependence on the irradiation/heating time tm. Again, this thermally induced shift of the focus position can be corrected by the calibration performed in step vi) in order to obtain an even focus position distribution across the irradiation plane I. Claims:
Please amend the claims as follows. This listing of claims is to replace all prior versions and listings of the claims in the application. 1-26. (cancelled)

27. A method for calibrating an irradiation system for use in an apparatus for producing a three-dimensional work piece by irradiating layers of a raw material powder with a radiation beam emitted by the irradiation system, the method comprising the steps of:
i) setting a distance between a calibration plane and an optical unit of the irradiation system in a z-direction perpendicular to the calibration plane to a first distance;
ii) while maintaining the distance between the calibration plane and the optical unit at the first distance, irradiating a first calibration pattern in a first x-y region within the calibration plane with a scanner mirror of the optical unit being arranged in a first angular basic position, and irradiating a second calibration pattern (p2.1) in a second x-y region within the calibration plane with the scanner mirror of the optical unit being arranged at a second angular basic position in which the scanner mirror is pivoted relative to the first angular basic position by at least ±1°;
iii) setting the distance between the calibration plane and the optical unit of the irradiation system in the z-direction perpendicular to the calibration plane to a second distance different from the first distance;
iv) while maintaining the distance between the calibration plane and the optical unit at the second distance, irradiating a third calibration pattern in the first x-y region within the calibration plane with the scanner mirror of the optical unit being arranged in the first angular basic position, and irradiating a fourth calibration pattern in the second x-y region within the calibration plane with the scanner mirror of the optical unit being arranged in the second angular basic position in which the scanner mirror is pivoted relative to the first angular basic position by at least ±1°;
v) evaluating the first, the second, the third and the fourth calibration pattern so as to determine focus positions of the radiation beam in the z-direction perpendicular to the calibration plane in dependence on an x-y position within the calibration plane; and
vi) calibrating the irradiation system based on the determined focus positions of the radiation beam.

28. The method according to claim 27, wherein - steps ii) and iv) to vi) are performed for a plurality of radiation beams; and/or - steps ii) and iv) to vi) are performed with the irradiation system having a plurality of different temperatures.

29. The method according to claim 28, wherein, for changing the temperature of the irradiation system, the irradiation system, prior to performing steps ii) and iv) to vi), is heated by irradiating a heating pattern in at least one heating region.

30. The method according to claim 28, wherein the irradiation system is set to a plurality of different temperatures by irradiating a plurality of heating patterns at a plurality of different output powers of the radiation beam emitted by the irradiation system and/or with a plurality of different irradiation times.

31. The method according to claim 27, wherein - step iii) is repeatedly performed so as to arrange the calibration plane at a plurality of further distances from the optical unit of the irradiation system, each of the further distances being different from the first and the second distance; and
-a plurality of further calibration patterns are irradiated in the first and the second x-y region in accordance with step iv), wherein the number of further calibration patterns irradiated in each of the first and the second x-y region corresponds to the number of further distances at which the calibration plane is arranged from the optical unit of the irradiation system.

32. The method according to claim 27, wherein, while the distance between the calibration plane and the optical unit of the irradiation system is maintained at at least one of the first, the second and the plurality of further distances, at least one additional calibration pattern is irradiated in an additional x-y region within the calibration plane which is different from the first and the second x-y region.

33. The method according to claim 27, wherein:
-the scanner mirror in the second angular basic position is pivoted relative to the first angular basic position by at least ±2°; and/or - a distance between a center of the first x-y region and a center of the second x-y region within the calibration plane corresponds to at least 15 times the diameter of the focused radiation beam.

34. The method according to claim 27, wherein the calibration plane is defined by at least one of:
-a surface of or a plane within a raw material powder layer applied onto a carrier (102);
-a surface of a burn-off film applied onto a carrier; and
-a surface of a calibration plate; and/or wherein the calibration patterns are detected by means of at least one of:
-an optical detection device recording the irradiation of the calibration patterns in situ, while the calibration patterns are irradiated on the calibration plane, and/or after the irradiation of the calibration patterns on the calibration plane has been completed;
-a light-sensitive sensor arrangement positioned on or beneath the calibration plane.

35. The method according to claim 27, wherein the calibration patterns comprise at least one line, and wherein the focus position of the radiation beam in the z-direction perpendicular to the calibration plane is determined in step v) based on an evaluation of a width of the lines of the calibration patterns.

36. The method according to claim 27, wherein at least one of the calibration patterns comprises a first block defined by a first plurality of substantially parallel lines and a second block defined by a second plurality of substantially parallel lines, wherein the second plurality of substantially parallel lines of the second block are arranged substantially perpendicular to the first plurality of substantially parallel lines of the first block, wherein the first plurality of substantially parallel lines of the first block extend in a radial direction relative to an optical center of the irradiation system.

37. The method according to claim 27, wherein an individual calibration pattern or a plurality of calibration patterns is/are provided with an identification marker which is indicative of the position of the individual calibration pattern or the plurality of calibration patterns within the calibration plane.

38. The method according to claim 27, wherein irradiation positions of a plurality of calibration patterns irradiated in a common x-y region within the x-y region are determined based upon an x-y offset of a point of incidence of the radiation beam on the calibration plane which is caused by the change of the distance between the calibration plane and the optical unit of the irradiation system in the z-direction.

39. A device for calibrating an irradiation system for use in an apparatus for producing a three-dimensional work piece by irradiating layers of a raw material powder with a radiation beam emitted by the irradiation system, the device comprising a control unit configured to:
i) set a distance between a calibration plane and an optical unit of the irradiation system in a z-direction perpendicular to the calibration plane to a first distance;
ii) while maintaining the distance between the calibration plane and the optical unit at the first distance, control the irradiation system so as to irradiate a first calibration pattern in a first x-y region within the calibration plane with a scanner mirror of the optical unit being arranged in a first angular basic position, and to irradiate a second calibration pattern in a second x-y region within the calibration plane with the scanner mirror of the optical unit being arranged at a second angular basic position in which the scanner mirror is pivoted relative to the first angular basic position by at least ±1°;
iii) set the distance between the calibration plane and the optical unit of the irradiation system in the z-direction perpendicular to the calibration plane to a second distance different from the first distance;
iv) while maintaining the distance between the calibration plane and the optical unit at the second distance, control the irradiation system so as to irradiate a third calibration pattern in the first x-y region within the calibration plane with the scanner mirror of the optical unit being arranged in the first angular basic position, and to irradiate a fourth calibration pattern in the second x-y region within the calibration plane with the scanner mirror of the optical unit being arranged in the second angular basic position in which the scanner mirror is pivoted relative to the first angular basic position by at least ±1°;
v) evaluate the first, the second, the third and the fourth calibration pattern so as to determine focus positions of the radiation beam in the z-direction perpendicular to the calibration plane in dependence on an x-y position within the calibration plane; and
vi) calibrate the irradiation system based on the determined focus positions of the radiation beam.

40. The device according to claim 39, wherein - the control unit is configured to perform steps ii) and iv) to vi) for a plurality of radiation beams; and/or - the control unit is configured to perform steps ii) and iv) to vi) with the irradiation system having a plurality of different temperatures.

41. The device according to claim 40, wherein, for changing the temperature of the irradiation system, the control unit is configured to heat the irradiation system, prior to performing steps ii) and iv) to vi), by irradiating a heating pattern in at least one heating region.

42. The device according to claim 40, wherein the control unit is configured to set the irradiation system to a plurality of different temperatures by irradiating a plurality of heating patterns at a plurality of different output powers of the radiation beam emitted by the irradiation system and/or with a plurality of different irradiation times.

43. The device according to claim 39, wherein the control unit is configured to - perform step iii) repeatedly so as to arrange the calibration plane at a plurality of further distances from the optical unit of the irradiation system, each of the further distances being different from the first and the second distance; and
-control the irradiation system so as to irradiate a plurality of further calibration patterns in the first and the second x-y region in accordance with step iv), wherein the number of further calibration patterns irradiated in each of the first and the second x-y region corresponds to the number of further distances at which the calibration plane is arranged from the optical unit of the irradiation system.

44. The device according to claim 39, wherein the control unit is configured to control the irradiation system so as to irradiate at least one additional calibration pattern in an additional x-y region within the calibration plane which is different from the first and the second x-y region, while the distance between the calibration plane and the optical unit is maintained at at least one of the first, the second and the plurality of further distances.

45. The device according to claim 39, wherein the control unit is configured to control the irradiation system such that:
-the scanner mirror in the second angular basic position is pivoted relative to the first angular basic position by at least ±2°; and/or - a distance between a center of the first x-y region and a center of the second x-y region within the calibration plane corresponds to at least 15 times the diameter of the focused radiation beam.

46. The device according to claim 39, wherein the calibration plane is defined by at least one of:
-a surface of or a plane within a raw material powder layer applied onto a carrier;
-a surface of a burn-off film applied onto a carrier; and
-a surface of a calibration plate; and/or wherein the device comprises at least one of the following detection systems for detecting the calibration patterns:
-an optical detection device configured to record the irradiation of the calibration patterns in situ, while the calibration patterns are irradiated on the calibration plane, and/or after the irradiation of the calibration patterns on the calibration plane has been completed;
-a light-sensitive sensor arrangement positioned on or beneath the calibration plane.

47. The device according to claim 39, wherein the calibration patterns comprise at least one straight line, curved line, dot or circle and wherein, the control unit is configured to determine the focus position of the radiation beam in the z-direction perpendicular to the calibration plane in step v) based on an evaluation of a width of the lines, dots or circles of the calibration patterns.

48. The device according to claim 39, wherein at least one of the calibration patterns comprises a first block defined by a first plurality of substantially parallel lines and a second block defined by a second plurality of substantially parallel lines, wherein the second plurality of substantially parallel lines of the second block are arranged substantially perpendicular to the first plurality of substantially parallel lines of the first block, wherein the first plurality of substantially parallel lines of the first block extend in a radial direction relative to an optical center of the irradiation system.

49. The device according to claim 39, wherein the control unit is configured to control the irradiation system such that an individual calibration pattern or a plurality of calibration patterns is/are provided with an identification marker which is indicative of the position of the individual calibration pattern or the plurality of calibration patterns within the calibration plane.

50. The device according to claim 39, wherein the control unit is configured to determine irradiation positions of a plurality of calibration patterns irradiated in a common x-y region within the x-y region based upon an x-y offset of a point of incidence of the radiation beam on the calibration plane which is caused by the change of the distance between the calibration plane and the optical unit of the irradiation system in the z-direction.

51. A computer program product comprising program portions for performing the method according to claim 27 when the computer program product is executed on one or more computing devices.

52. An apparatus for producing a three-dimensional work piece by irradiating layers of a raw material powder with a radiation beam, the apparatus comprising an irradiation system and a device according to claim 39.

53. An apparatus for producing a three-dimensional work piece by irradiating layers of a raw material powder with a radiation beam, the apparatus comprising an irradiation system and a computer-readable recording medium on which the computer program product according to claim 51 is stored.
